(19) United States
(12) Patent Application Publication
(10) Pub. No.: US 2017/0017965 A1
(43) Pub. Date: Jan. 19, 2017

(54) INFORMATION TECHNOLOGY (IT) TICKET ASSIGNMENT

(71) Applicant: HEWLETT PACKARD ENTERPRISE DEVELOPMENT LP, Houston, TX (US)

(72) Inventors: Elad Hotman, Yehud (IL); Gil Tzadikevitch, Yehud (IL); Arik Sityon, Yehud (IL)

(21) Appl. No.: 15/124,020

(22) PCT Filed: Mar. 27, 2014
(86) PCT No.: PCT/US14/32012

§ 371 Date: Sep. 6, 2016

(51) Int. Cl. G06Q 30/00; G06Q 10/06

(52) U.S. Cl. CPC G06Q 30/016; G06Q 10/06311

(57) ABSTRACT

A system includes a search window selection engine to determine a search window size based on a time period associated with an information technology (IT) ticket and select a search window of the determined search window size. The system also includes a time period instance merge engine to merge overlapping time periods of a positive type and merge overlapping time periods of a negative type. The positive type is acceptable for assignment of the IT ticket and the negative type is not acceptable for assignment of the IT ticket. The system also includes an IT assignment engine to assign the IT ticket in the selected search window based on whether the merged overlapping time period instances of the positive type is of a time length at least equal to the time period associated with IT ticket. Methods are also disclosed.

### BACKGROUND

Many organizations have various hardware and software systems to manage various aspects of the organization's operations. Larger and more extensive organizations tend to have larger and more extensive hardware and software systems. Such systems may need to be upgraded or repaired from time to time. The change to the system (e.g., loading new software, upgrading servers, etc.) takes time to complete, and the change process itself may interfere with the normal operations of the system and the personnel using the system.

### BRIEF DESCRIPTION OF THE DRAWINGS

For a detailed description of various examples, reference will now be made to the accompanying drawings in which;

FIG. 1 shows a system in accordance with various principles;

FIG. 2 shows an implementation of the system of FIG. 1 in accordance with various principles;

FIG. 3a-3d illustrate an example of assigning an information technology (IT) ticket in a selected search window in accordance with various principles;

FIG. 4 shows a method in accordance with various principles;

FIG. 5 shows another method in accordance with various principles; and

FIG. 6 shows an example of splitting apart a positive type time period instance.

### DETAILED DESCRIPTION

An information technology (“IT”) change” is a change to hardware and/or software. The IT change, for example, may be to replace or upgrade a hardware or software component. By way of an additional example, an IT change may be to add a hardware or software component to an existing system. An “IT ticket” is a record that represents a particular IT event. If the IT event is to implement an IT change, the ticket may be referred to as an “IT change ticket.” The present disclosure may at times refer to an IT ticket but in at least some embodiments, the IT ticket is an IT change ticket.

An IT change ticket specifies the particular change needed to the system as well as a time period associated with the ticket. The time period indicates the amount of time that is anticipated to be required to implement the IT change indicated by the ticket. The time period may be 30 minutes, 3 hours, 3 days, or any other time period.

Once an IT change ticket is created and it is known how much time the corresponding IT change will require, the issue becomes how to schedule the IT change. Some changes may impact multiple systems and groups of personnel, and each such system and personnel group may have its own preferences for when changes to the hardware and software systems they need can be made so as not to impact their productivity. For example, an organization's accounting department may prefer that the systems that the accounting department needs not be taken off-line for an IT change during the last few days of each month or at the end of each quarter. Other departments may have different preferences for when the systems on which they rely should remain operational and not be taken off-line for an IT change. Thus, a particular IT change may require various hardware and/or software systems to be taken off-line during performance of the IT change and such systems may impact multiple aspects of the organization, each with its own schedule.

A “blackout period” is a period of time during which an IT change should not be made. Individual subdivisions (e.g., departments) of an organization and individual hardware and/or software systems may have their own schedule of blackout periods. The scheduled blackout periods may be specified on any granularity of time (e.g., by minute, hour, day, etc.) and may be specified as far into the future as desired (e.g., one year). An entity is a subdivision of an organization, an individual, a hardware component, or a software component for which certain days and times are better or worse for an IT change to be performed that impacts that entity. In some implementations, positive and negative type time period instances may be specified for a particular entity. A positive type time period instance defines a period of time during which an IT change can be made without detrimentally impacting the corresponding entity. Thus, a positive type time period instance is acceptable for assignment of the IT change ticket. A negative type time period instance defines a period of time during which an IT change should not be made to the systems impacted by the change. That is, a negative type time period instance is not acceptable for assignment of the IT change ticket. Each entity may have its own calendar of positive and negative time period instances. The positive and negative time period instances may overlap, or not, between different instances.

Once an IT change has been approved and an IT change ticket has been created, the IT change ticket must be scheduled for the IT change to be performed. That is, a determination is made as to when the IT ticket change specified by the change ticket is to performed. In accordance with various implementations, each IT change ticket is scheduled taking into account the positive and negative type time period instances of the various entities that may be affected by the particular IT change. Various scheduling examples are illustrated herein that may be particularly efficient (at least more efficient than other techniques). Efficiency in determining how to schedule an IT change is particularly helpful if the tool determining the suitable time to schedule the change is implemented as a web-based system. At least in some embodiments, the tool described herein may be implemented as a web-based tool.

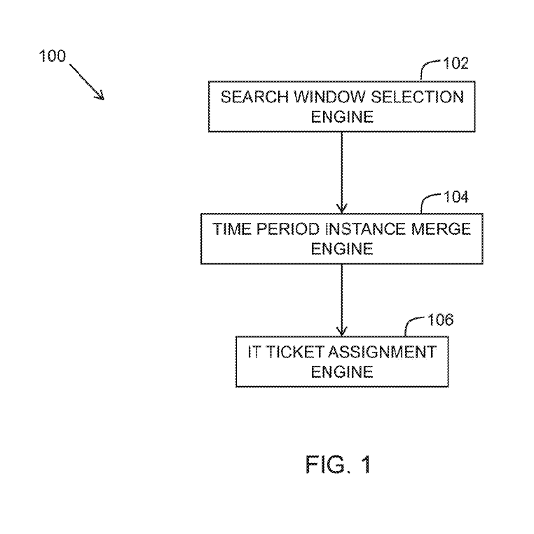

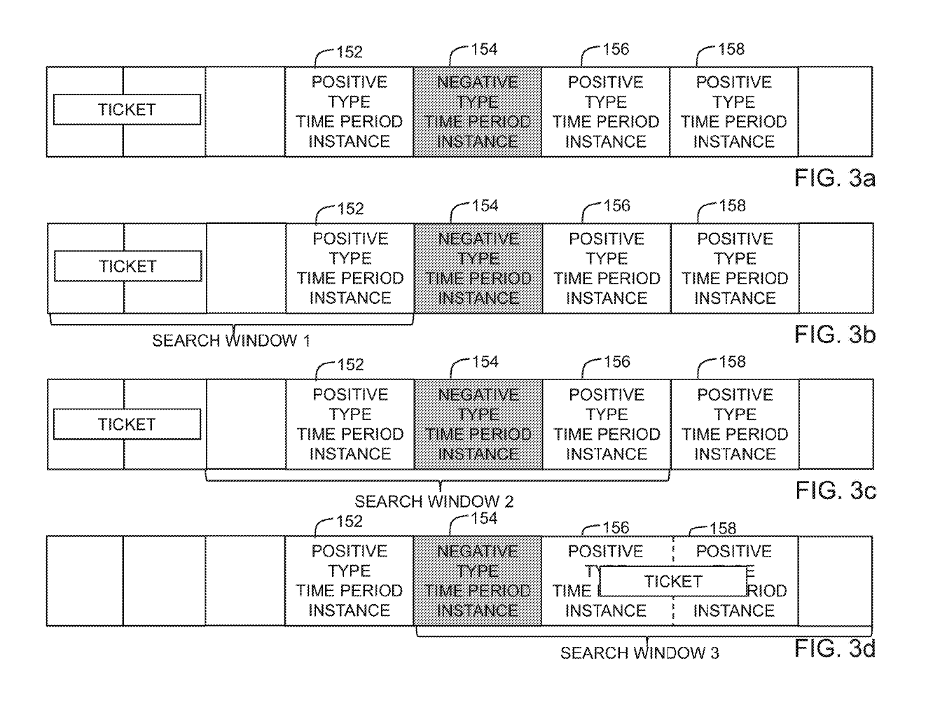

FIG. 1 shows an example of a system 100 in accordance with the principles disclosed herein. The system includes a search window selection engine 102, a time period instance merge engine, and an IT ticket assignment engine 106. The operations performed by the engines of FIG. 1 will be explained below with regard to FIGS. 3a-3d.

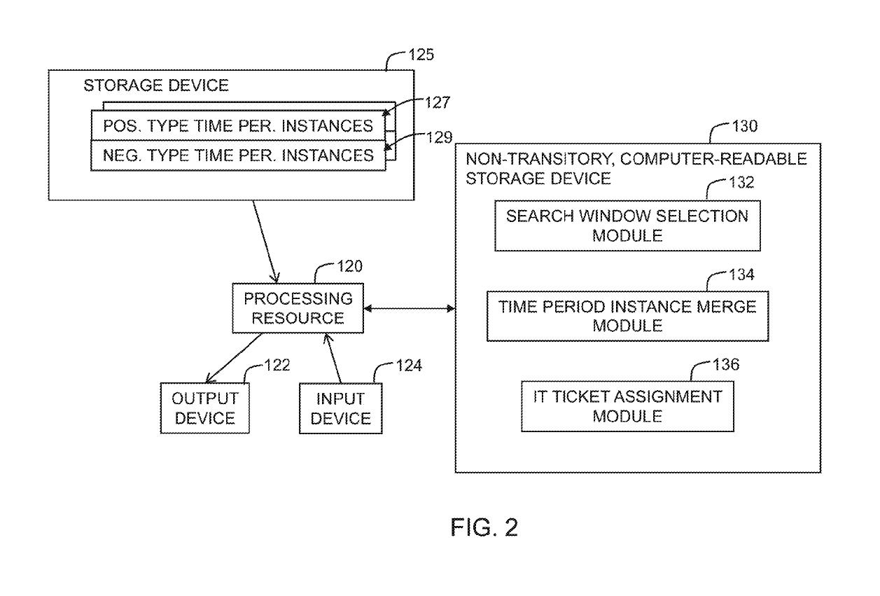

FIG. 2 illustrates an implementation of the system of FIG. 1. FIG. 2 shows a processing resource 120 coupled to a non-transitory, computer-readable storage device 130 as well as to an output device 122 and an input device 124. The processing resource 120 may be an individual processor, multiple processors, a computer, multiple computers, or any other type of hardware processing resource. The non-transitory, computer readable storage device 130 may be part of the processing resource 120 or be connected to, but separate from, the processing resource. In some examples, the non-transitory, computer readable storage device 130 may be coupled to the processing resource via a network (local area network, wide area network, etc.).

The non-transitory, computer readable storage device 130 may be implemented as volatile memory (e.g., random access memory), non-volatile memory (e.g., hard drive, flash memory, etc.), or combinations thereof. The output device 122 may be any type of user output device such as a display and the input device 124 may be any type of user-input device such as any one or more of a keyboard, mouse, trackpad, etc. The output device 122 and input device 124 may be connected directly to the processing resource 120 or may be part of a separate computer coupled to the processing resource 120 via a network. In some implementations, the processing resource 120 may implement a web-based service and the output device 122 and input device 124 may access the web-based service over the Internet.

FIG. 2 also illustrates that the non-transitory, computer readable storage device 130 includes various modules 132-136. Each such module includes machine readable instructions that are executable by the processing resource 120. Each engine 102-106 in FIG. 1 is implemented as the processing resource 120 executing the corresponding module 132-136. For example, the search window selection engine 102 is implemented as the processing resource 120 executing the search window selection module 132. Similarly, the time period instance merge engine 104 is implemented as the processing resource 120 executing the time period instance merge module 134. The IT ticket assignment engine 106 is implemented as the processing resource 120 executing the IT ticket assignment module 136.

FIG. 2 also shows a storage device 125 which is accessible to the processing resource 120 either directly or remotely via a network connection. The storage device 125 includes one or more positive type time period instances and one or more negative type time period instances 129 for each entity. The positive and negative type time period instances may include multiple such time periods over the ensuing days, weeks, months or year. Each entity of an organization may store, or caused to be stored, its own set of positive and negative type time period instances.

FIGS. 3a-3d show an example of a portion of calendar with various positive and negative type time period instances. A particular IT change ticket 150 is to be scheduled by system 100 taking into account the various positive and negative type period instances of the entities that would be impacted by the particular IT change specified by the IT change ticket 150. FIG. 3a shows the IT change ticket 150 and three positive type period instances 152, 156, and 158 and a negative type period instance 154 between the positive type time period instances 152 and 156. The various positive and negative type time period instances 152-158 may be for the same or different entities. For example, positive time period instance 156 and 158 may be for different entities. The various time period instances are retrieved from storage device 125 by the search window selection engine 102 based on the IT ticket to be scheduled and assessment of which entities may be impacted by the IT change. The example presented below is for the scheduling of an IT change ticket, but the disclosed principles may apply to other types of IT tickets to be scheduled as well.

The size of each time period instance may be any suitable time period (e.g., 30 minutes, 1 hour, 3 days, etc.), The IT change ticket 150 to be scheduled spans two such time periods. This means that the system 100 is to discover one or more consecutive positive type period instances that are long enough to permit the IT change identified in the IT change ticket 150 to be performed.

In accordance with various examples, the system 100 determines how to schedule the IT change reflected in the IT change ticket 150 in a step-wise approach. Each step corresponds to a particular search window. The length of each search window may be larger than the time period of the IT ticket itself, In the example of FIGS. 3a-3d, the time period of each search window is double the time period of the IT ticket, but can be other than double in other examples. The search window selection engine 102 determines the search window size based on the time period associated with the IT ticket change 150 to be scheduled.

FIG. 3b illustrates a first search window (search window 1). The search window selection engine 102 selects the first search window 1. In search window 1, four time periods are analyzed by system 100. For each time period in search window 1, the time period instance merge engine 104 merges overlapping positive type time period instances (if any) and separately merges overlapping negative type time period instances (if any). Two time period instances are deemed to be overlapping if a beginning time of one time period instance is between the beginning and ending time of another time period instance, or if a start time of one time period instance coincides with the ending time period of another time period instance (e.g., back-to-back time period instances). The merger of overlapping time period instances of the same type makes the scheduling process run more efficiently than if such mergers did not occur.

Search window 1 in the example of FIG. 3b only includes one time period instance, which is the positive type time period instance 152. There are not multiple time period instances to merge in search window 1 and, as determined by IT ticket assignment engine 106, the one positive type time period instance is not large enough to accommodate the IT change specified by IT change ticket 150. Thus, the IT change ticket 150 is not assigned in search window 1. The search window selection engine 102 thus selects the next search window 2.

In the example of FIG. 3c, search window 2 is selected so as to overlap with search window 1 by two time periods. The amount of overlap may different in other examples, and no overlap is possible as well. The process described above repeats for search window 2. As can be seen in FIG. 3c, there are no overlapping time period instances of the same type and thus no merging occurs. Further, the IT ticket assignment engine 106 determines that search window 2 does not include a positive type time period instance large enough to accommodate the IT change specified by IT change ticket 150 and thus the IT change ticket is not assigned in search window 2. Positive type time period instances 152 and 156 collectively are large enough to accommodate IT change ticket 150, but because they do not overlap each other and are separated by negative type time period instance 154 (i.e., are not contiguous), the IT ticket is not assigned in search window 2. Thus, the search window selection engine 102 selects the next search window 3 (which also overlaps previous search window 2).

In search window 3 (FIG. 3d), the time period instance merge engine 104 detects the presence of two overlapping positive type time period instances 156 and 158 and merges them together (as indicated by the dashed line separating the two time period instances) for processing as one positive type period instance 160. Search window 3 includes a negative time period instance 154 followed by a merged positive time period instance 160 that spans two time periods. The merged positive time period instance 160 is large enough to accommodate the IT change specified IT ticket change 150, and thus the IT ticket assignment engine 106 assigns the IT change ticket in search window 3, and specifically to the merged positive time period instance 160 as shown. At this point, the IT ticket has been assigned and the scheduling process stops. The scheduling process described herein processes smaller windowed subsets of all of time period instances from storage device 125 thereby making the process more efficient than if all of the time period instance data were retrieved initially and merged.

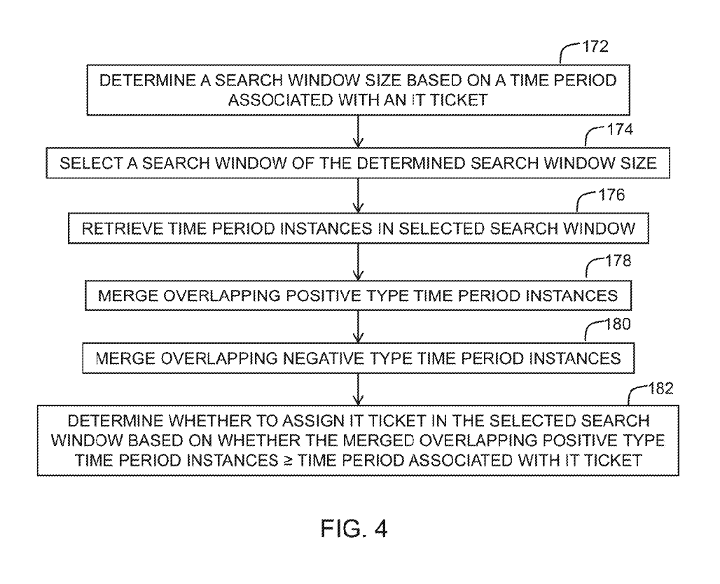

FIG. 4 illustrates a method in accordance with various examples. The various engines from FIG. 1 that perform each of the operations shown in FIG. 4 are identified below, but in general, each operation is performed by the processing resource 120 of FIG. 2.

At 172, the method includes determining a search window size based on a time period associated with an IT ticket. In some examples, the size of the determined search window is larger than the time period associated with an IT ticket to be scheduled. In one example, the search window is double the time needed by the IT change specified by an IT change ticket. At 174, the method further includes selecting a search window of the determined search window size. Selecting the search window includes defining its starting and ending times. Operations 172 and 174 may be performed by the search window selection engine 102.

At 176, the method includes retrieving time period instances that occur in the selected search window. As explained above, the retrieved time period instances may be of the positive type (acceptable for assignment of the IT ticket) or of the negative type (not acceptable for assignment of the IT ticket). This operation may be performed by time period instance merge engine 104. The retrieved time period instances are for the entities that would be impacted by the IT change ticket. The ticket may specify those entities and the time period instance merge engine 104 may then retrieve the relevant time period instances from storage device 125.

At 178, the method includes merging the overlapping positive type time period instances and, at 180, merging the overlapping negative type time period instances. These operations are also performed by the time period instance merge engine 104. The act of merging two time period instances may include storing only the storing and/or using the starting time of the earliest instance and the ending time of the most distant (in time) instance and ignoring the intermediate starting and ending times.

At 182, the method of FIG. 4 includes determining whether to assign the IT ticket in the selected search window based on whether the merged overlapping time period instances of the positive type is of a time length at least equal to the time period associated with IT ticket. This determination may be performed by the IT assignment engine 106.

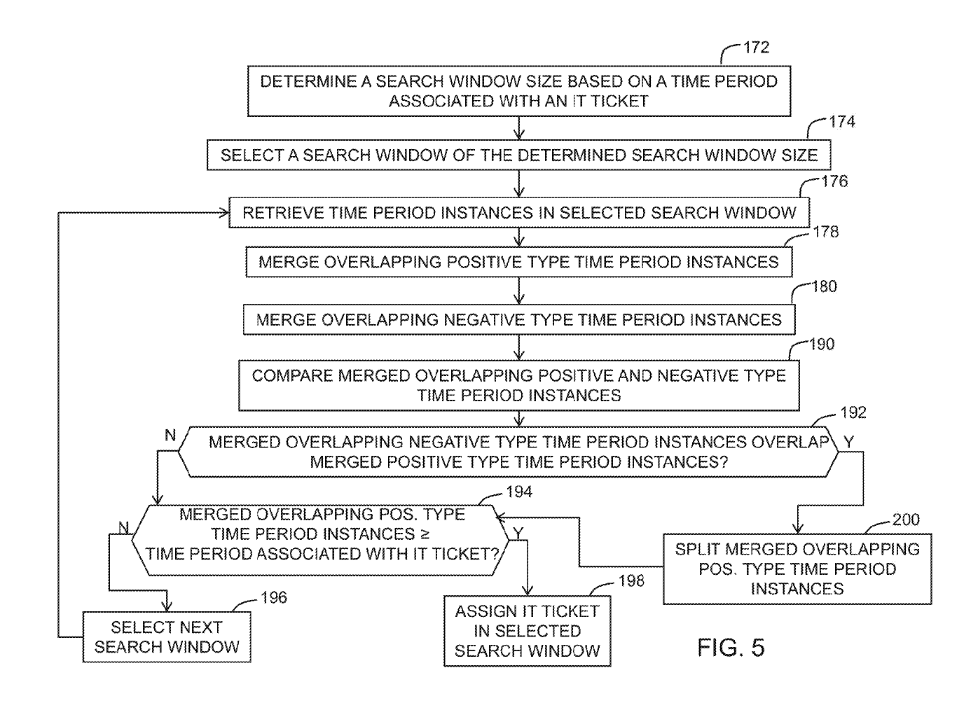

FIG. 5 shows another example of a method in accordance with the disclosed principles. The various engines from FIG. 1 that perform each of the operations shown in FIG. 5 are identified below, but in general, each operation is performed by the processing resource 120 of FIG. 2.

Operations 172-180 are the same as shown in FIG. 4 and thus a discussion of those operations is not repeated. At 190, the method of FIG. 5 includes comparing the merged overlapping positive type (if any) and negative type (if any) time period instances to determine (192) whether any merged overlapping negative type time period instances overlap any merged positive type time period instances in the particular search window. This comparison applies as well to individual time period instances that do not overlap other time period instances of the same type and thus are not mergeable. The comparison and determination operations 190 and 192 may be performed by time period instance merge engine 104.

If no negative type time period (merged or individual) overlaps a positive type time period instance (merged or individual), then at 194, the method includes determining whether any merged or individual positive type time period instances in the search window is greater than or equal to the time period associated with the IT ticket. If such a positive type time period exists, then at 198, the method includes assigning the IT ticket in the current selected search window. However, if a positive type time period (merged or individual) of such sufficient length (at least equal to the time period associated with the IT ticket) is not present in the search window, then at 196, the method includes selecting the next search window (e.g., a search window which overlaps the current search window), and the process loops back to operation 176. Operations 194 and 198 may be performed by the IT ticket assignment engine 106 and operation 196 may be performed by the search window selection engine 102.

Returning to decision operation 192, if a merged or individual negative type time period instance does overlap a merged or individual positive type time period instance, then at 200, the method includes splitting the overlapped positive type period instance so that only contiguous positive type period instances are considered for assignment of the IT ticket. Control then flows to operation 194.

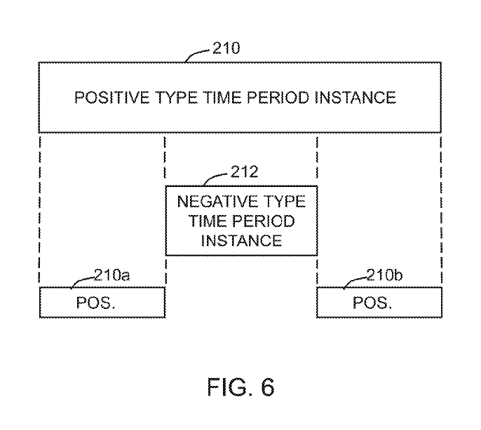

FIG. 6 shows an example of splitting a positive type time period instance 210 into two parts 210a and 210b because of the existence of an intervening negative type time period instance 212. As can be seen, following the split, the positive type time period 210a starts when positive type time period instance 210 would have started and ends when negative type time period instance 212 starts, Similarly, positive type time period 210b starts when negative type time period instance 212 ends, and positive type time period 210b ends when positive type time period instance 210 would have ended.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a search window selection engine to determine a search window size based on a time period associated with an information technology (IT) ticket and select a search window of the determined search window size;
a time period instance merge engine to merge overlapping time periods of a positive type and merge overlapping time periods of a negative type, wherein the positive type is acceptable for assignment of the IT ticket and the negative type is not acceptable for assignment of the IT ticket; and
an IT assignment engine to assign the IT ticket in the selected search window based on whether the merged overlapping time period instances of the positive type is of a time length at least equal to the time period associated with IT ticket.

2. The system of claim 1 wherein the IT ticket is a change ticket.

3. The system of claim 2 wherein the time period instance merge engine is further to compare the merged overlapping time period instances of the positive type and the merged overlapping time period instances of the negative type

4. The system of claim 3 wherein the time period instance merge engine is further to split the merged overlapping time period instances of the positive type if the merged overlapping time period instances of the negative type overlap the merged overlapping time period instances of the positive type

5. The system of claim 1 wherein the IT assignment engine is to:
determine whether the merged overlapping time period instances of the positive type is not of a time length at least equal to the time period associated with IT ticket;
based on a determination that the merged overlapping time period instances of the positive type is not of a time length at least equal to the time period associated with IT ticket, to select a next search window that overlaps a previously selected search window, and to determine whether to assign the IT ticket in the next selected search window.

6. The system of claim 1 wherein the search window selection engine is to determine the search window size to be larger than the time period associated with the IT ticket.

7. A non-transitory, computer-readable storage device containing machine readable instructions that, when executed by a processing resource, cause the processing resource to:
determine a search window size based on a time period associated with an information technology (IT) ticket;
select a search window of the determined search window size;
retrieve time period instances that occur in the selected search window, each time period instance being either of a positive type or a negative type, wherein the positive type is acceptable for assignment of the IT ticket and the negative type is not acceptable for assignment of the IT ticket;
merge overlapping time period instances of the positive type;
merge overlapping time period instances of the negative type; and
determine whether to assign the IT ticket in the selected search window based on whether the merged overlapping time period instances of the positive type is of a time length at least equal to the time period associated with IT ticket.

8. The non-transitory, computer-readable storage device of claim 7 wherein the IT ticket is a change ticket.

9. The non-transitory, computer-readable storage device of claim 7 wherein, when executed, the machine readable instructions further cause the processing resource to compare the merged overlapping time period instances of the positive type and the merged overlapping time period instances of the negative type.

10. The non-transitory, computer-readable storage device of claim 9 wherein, when executed, the machine readable instructions further cause the processing resource to split the merged overlapping time period instances of the positive type if the merged overlapping time period instances of the negative type overlap the merged overlapping time period instances of the positive type.

11. The non-transitory, computer-readable storage device of claim 7, based on a determination that the merged overlapping time period instances of the positive type is not of a time length at least equal to the time period associated with IT ticket, when executed, the machine readable instructions cause the processing resource to select a next search window that overlaps a previously selected search window, and for the next selected search window:
retrieve time period instances that occur in the next selected search window, each time period instance being either of the positive type or the negative type;
merge overlapping time period instances of the positive type;
merge overlapping time period instances of the negative type; and
determine whether to assign the IT ticket in the next selected search window based on whether the merged overlapping time period instances of the positive type is of a time length at least equal to the time period associated with IT ticket.

12. The non-transitory, computer-readable storage device of claim 7 wherein, when executed, the machine readable instructions cause the processing resource to determine the search window size to be twice the time period associated with the IT ticket.

13. A method, comprising:
determining, by a processing resource, a search window size based on a time period associated with an information technology (IT) ticket, the determined window size to be larger than the time period associated with the IT ticket;
selecting, by the processing resource, a search window of the determined search window size;
retrieving, by the processing resource, time period instances that occur in the selected search window, each time period instance being either of a positive type or a negative type, wherein the positive type is acceptable for assignment of the IT ticket and the negative type is not acceptable for assignment of the IT ticket;
merging, by the processing resource, overlapping time period instances of the positive type if a plurality of time period instances of the positive type are present and overlapping in the search window;
merging, by the processing resource, overlapping time period instances of the negative type if a plurality of time period instances of the negative type are present and overlapping in the search window; and
determining, by the processing resource, whether to assign the IT ticket in the selected search window based on whether the merged overlapping time period instances of the positive type is of a time length at least equal to the time period associated with IT ticket.

14. The method of claim 13 further comprising:
comparing the merged overlapping time period instances of the positive type and the merged overlapping time period instances of the negative type; and
splitting the merged overlapping time period instances of the positive type if the merged overlapping time period instances of the negative type overlap the merged overlapping time period instances of the positive type.

15. The method of claim 13 further comprising, based on determining that the merged overlapping time period instances of the positive type is not of a time length at least equal to the time period associated with IT ticket, selecting a next search window that overlaps a previously selected search window, and for the next selected search window:
retrieving time period instances that occur in the next selected search window, each time period instance being either of the positive type or the negative type;
merging overlapping time period instances of the positive type;
merging overlapping time period instances of the negative type; and
determining whether to assign the IT ticket in the next selected search window based on whether the merged overlapping time period instances of the positive type is of a time length at least equal to the time period associated with IT ticket.
